(19) United States
(12) Patent Application Publication
(10) Pub. No.: US 2008/0166651 A1
(43) Pub. Date: Jul. 10, 2008

(54) TONER HAVING CROSSLINKED RESIN FOR CONTROLLING MATTE PERFORMANCE

(75) Inventors: Daryl W. VANBESIEN, Burlington (CA); Edward G. ZWARTZ, Mississauga (CA); Karen A. MOFFAT, Brantford (CA); Emily L. MOORE, Mississauga (CA); Shigang QIU, Etobicoke (CA)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/555,585

(22) Filed: Nov. 1, 2006

(51) Int. Cl. G03G 9/00

(52) U.S. Cl. 430/109.3

(57) ABSTRACT

A toner composition comprising a crosslinked resin, a substantially non-crosslinked resin, a was, and a colorant. The crosslinked resin has a crosslinked density of from about 0.3 percent to about 30 percent.

### BACKGROUND

Disclosed herein are toner compositions suitable for printing images with a low gloss, that is matte finish. The toner compositions disclosed herein comprise a crosslinked resin having a crosslinked density of from about 0.3 percent to about 30 percent.

### REFERENCES

U.S. Publication No. 2006-0121384 to Patel, which is incorporated herein in its entirety by reference, discloses toner compositions and processes, such as emulsion aggregation toner processes, for preparing toner compositions comprising a resin substantially free of crosslinking, a crosslinked resin, a wax and a colorant.

U.S. patent application Ser. No. 11/272,720 to Patel et al., which is incorporated herein in its entirety by reference, is directed to toner compositions and processes, such as emulsion aggregation toner processes, for preparing toner compositions comprising a high molecular weight non-crosslinked resin such as having a weight average molecular weight of at least 50,000, a wax, and a colorant.

Emulsion/aggregation (EA) toner particles are prepared by a process known in the art. Such a process includes the aggregation of various toner components beginning with stable dispersions or latexes of each component, followed by the coalescence of the particles at elevated temperature. The components incorporated into the toner are chosen to provide all the necessary requirements for the final toner particle. A colorant may be added for color, a wax may be added to provide release from the fuser roll for oil-less fuser systems, and a binder resin may be designed to provide a low minimum fusing temperature (MFT). Another key toner property which may be controlled by the components of the EA toner particles is fused image gloss. This feature is particularly important when designing EA toners for providing low gloss or matte images.

Thus, it is still desired to improve the components and design parameters of EA toner that may lower the gloss, or improve the matte finish of printed images formed from EA toner.

### SUMMARY

In embodiments, described is a toner composition having toner particles comprised of a crosslinked resin, a substantially non-crosslinked resin, a wax, and a colorant, wherein the crosslinked resin has a crosslinked density of from about 0.3 percent to about 30 percent.

In further embodiments, described is a toner process comprising mixing crosslinked resin having a crosslinked density of from about 0.3 percent to about 30 percent, a substantially non-crosslinked resin, a wax and a colorant to provide toner size aggregates, heating the aggregates to form the toner, and optionally, isolating the toner.

In yet further embodiments, described is a method of developing an image, comprising applying a toner composition to a substrate to form an image, the toner composition comprising a crosslinked resin, a substantially non-crosslinked resin, a wax, and a colorant, and fusing the toner composition to the substrate, wherein the crosslinked resin has a crosslinked density of from about 0.3 percent to about 30 percent.

### EMBODIMENTS

Toner particles may include a crosslinked resin or gel, a substantially non-crosslinked resin, a wax and colorant.

In embodiments, the crosslinked resin or gel has a crosslinked density between about 0.3 percent to about 30 percent. The crosslinked resin or gel may be included in the toner particles to control the gloss of the printed images. As described in more detail below, the crosslinked resin or gel may be included in the toner particles in various amounts to control, or “dial in,” the amount of gloss the printed toner image exhibits.

In embodiments, the crosslinked resin content of the toner particles may be preselected and controlled at the outset of the process. This enables a high level of control over the gloss properties of the resulting toner particles. The amount of crosslinked resin in the toner particle formulation may be adjusted throughout the emulsion polymerization process to control the gloss properties of the resultant toner. For example, a toner particle having from about 4 weight percent to about 30 weight percent crosslinked resin may exhibit a gloss of from about 1 to about 20 gloss units as measured on a BYK 75 degree micro gloss meter. “Gloss units” refers to Gardner Gloss Units measured on plain paper.

As used herein, the terms “non-crosslinked resin” and “crosslinked resin” also refer to a non-crosslinked gel and a crosslinked gel, respectively.

Both the substantially non-crosslinked resin and the crosslinked resin suitable for use herein comprise latex resins or polymers. In embodiments, the latex resins or polymer may be the same or different in the non-crosslinked resin and the crosslinked resin. In further embodiments, the non-crosslinked resin and the crosslinked resin comprise the same latex resin(s) or polymer(s).

Suitable latex resins or polymers include styrene acrylates, styrene methacrylates, butadienes, isoprene, acrylonitrile, acrylic acid, methacrylic acid, beta-carboxy ethyl arylate, polyesters, known polymers such as poly(styrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), polymethyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and the like. In embodiments, the resin or polymer is a styrene/butyl acrylate/beta-carboxyethylacrylate terpolymer.

In embodiments, the crosslinked latex may be prepared from a non-crosslinked latex comprising monomers of styrene, butyl acrylate, a carboxyl acid containing monomer, such as beta-carboxyethylacrylate (beta-CEA), divinylbenzene, a surfactant and an initiator. The crosslinked latex may be prepared by emulsion polymerization.

Other examples of carboxyl acid containing monomers include maleic acid, citraconic acid, itaconic acid, alkenyl succinic acid, fumaric acid, mesaconic acid, maleic-acid anhydride, citraconic anhydride, itaconic-acid anhydride, alkenyl succinic-acid anhydride, maleic-acid methyl half ester, maleic-acid ethyl half ester, maleic-acid butyl half ester, citraconic-acid methyl half ester, citraconic-acid ethyl half ester, citraconic-acid butyl half ester, itaconic-acid methyl half ester, alkenyl succinic-acid methyl half ester, fumaric-acid methyl half ester, half ester of the partial saturation dibasic acid such as mesaconic acid methyl half ester, dimethyl maleic acid, the partial saturation dibasic acid ester such as dimethyl fumaric acid, acrylic acid, methacrylic acid, alpha like crotonic acid, cinnamon acid, beta-partial saturation acid, crotonic-acid anhydride, cinnamon acid anhydride, alkenyl malonic acid, a monomer which has an alkenyl glutaric acid, alkenyl adipic acids and mixtures thereof and the like.

The crosslinked resins may include from about 30 weight percent to about 99.9 weight percent styrene of the starting monomers, such as from about 35 weight percent to about 90 weight percent or from about 30 weight percent to about 80 weight percent styrene of the starting monomers.

The crosslinked resins may include from about 5 weight percent to about 50 weight percent butyl acrylate of the starting monomers, such as from about 10 weight percent to about 45 weight percent or from about 12 weight percent to about 40 weight percent of butyl acrylate of the starting monomers.

The crosslinked resins may include styrene and butyl acrylate in a ratio of from about 50:50 to about 80:20 of styrene:butyl acrylate in the starting monomers, such as from about 60:40 to about 70:30 or about 65:35 of styrene:butyl acrylate in the starting monomers.

The crosslinked resins may include from about 0.05 weight percent to about 15 weight percent carboxyl acid containing monomer of the starting monomers, such as from about 0.1 weight percent to about 10 weight percent or from about 1 weight percent to about 6 weight percent carboxyl acid containing monomer of the starting monomers.

The crosslinked resins may include from about 0.25 weight percent to about 40 weight percent divinylbenzene of the starting crosslinking monomers, such as from about 0.5 weight percent to about 20 weight percent or from about 1 weight percent to about 15 weigh percent of divinylbenzene of the starting crosslinking monomers.

Examples of crosslinking agents suitable for use herein include divinylbenzene, divinylnaphthalene, ethylene glycol diacrylate, 1,3-butyleneglycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, polyethylene-glycol #400 diacrylate, dipropylene glycol diacrylate, and polyoxyethylene (2)-2,2-bis(4-hydroxyphenyl) propane diacrylate and mixtures thereof and the like.

The amount of the divinylbenzene present in the resin affects the crosslink density of the resin. For example, a greater amount of divinylbenzene in the resin correlates to a greater crosslinked density. In embodiments, the crosslinked density of the resin is from about 0.3 percent to about 40 percent, such as from about 0.3 percent to about 35 percent or from about 0.3 percent to about 30 percent crosslink density.

As used herein “crosslinked density” refers to the mole fraction of monomer units which are linked to another polymer chain at this point. For example, in a system where 1 of every 20 molecules is a divinylbenzene and 19 of every 20 molecules is a styrene, only 1 of 20 molecules would crosslink. Thus, in such a system, the crosslinked density would be 0.05.

The crosslinked density of the crosslinked resin affects the crosslinked density of the overall toner.

The more divinylbenzene used in a formulation, the higher the crosslinking will be. Therefore, a higher crosslinked density since more divinylbenzene means more chances for the polymer to connect with another polymer. For example, if there is about 11 percent crosslinked resin in the toner by weight, the overall crosslink density will be “diluted” to be from about 0.03 percent to about 0.1 percent.

In embodiments, the glass transition temperature (Tg) of the crosslinked resin may be from about 30° C. to about 65° C., such as from about 35° C. to about 60° C. or from about 40° C. to about 55° C.

The soluble portion of the crosslinked resin may have a weight average molecular weight (Mw) of from about 100,000 to about 200,000, such as a molecular weight of from about 115,000 to about 175,000 or from about 125,000 to about 150,000. In embodiments, the number average molecular (Mn) of the crosslinked resin may be from about 15,000 to about 50,000, such as from about 20,000 to about 35,000 or from about 23,000 to about 30,000.

The particle size (diameter) of the crosslinked resin may be from about 10 nanometers to about 350 nanometers, such as from about 15 nanometers to about 300 nanometers or from about 20 nanometers to about 250 nanometers.

In order to control the molecular weight of the crosslinked resin, the resin may be prepared, for example, by emulsion polymerization methods, optionally in the presence of a chain transfer agent, an initiator and a surfactant.

Other processes of obtaining crosslinked resin may include a polymer microsuspension process, such as the processes disclosed in U.S. Pat. No. 3,674,736, the disclosure of which is totally incorporated herein by reference, a polymer solution microsuspension processes, such as disclosed in U.S. Pat. No. 5,290,654, the disclosure of which is totally incorporated herein by reference, mechanical grinding processes, or any other known processes.

The toner particles also include a resin that is substantially free of crosslinking. In embodiments, the resin that is substantially free of crosslinking (also referred to herein as a non-crosslinked resin) comprises a resin having a crosslink density less than about 0.1 percent, such as less than about 0.05. For example, the non-crosslinked latex comprises styrene, butyl acrylate, and beta-CEA monomers prepared, for example, by emulsion polymerization in the presence of an initiator, a chain transfer agent (CTA), and surfactant. The absence of divinylbenzene or similar crosslinking agents avoids crosslinking.

In embodiments, the resin substantially free of crosslinking comprises styrene:butyl acrylate:beta-CEA wherein, for example, the non-crosslinked resin monomers include from about 70 weight percent to about 90 weight percent styrene, from about 10 weight percent to about 30 weight percent butyl acrylate, and from about 0.05 weight percent to about 10 weight percent beta-CEA.

An initiator suitable for use in producing both the crosslinked resin and the substantially non-crosslinked resin may be, for example, sodium, potassium or ammonium persulfate and may be present in both the crosslinked starting monomers and non-crosslinked starting monomers in the range of from about 0.1 weight percent to about 5 weight percent, such as from about 0.3 weight percent to about 4 weight percent or from about 0.5 weight percent to about 3 weight percent of an initiator based upon the total weight of the monomers. In embodiments, the surfactant may be present in the range of from about 0.3 weight percent to about 10 weight percent, such as from about 0.5 weight percent to about 8 weight percent or from about 0.7 to about 5.0 weight percent of surfactant.

Both the crosslinked resin and the substantially non-crosslinked resin may be produced by similar methods. However, in producing the substantially non-crosslinked resin, no divinylbenzene or similar crosslinking agent is used. The resins may be made by any suitable method. One example of a suitable method is described below for illustration.

First, a surfactant solution is prepared by combining an anionic surfactant with water. The anionic surfactant is present in the amount from about 0.01 to about 15, or more preferably from about 0.01 to about 5 weight percent of the reaction mixture.

Surfactants suitable for use herein may be ionic or nonionic surfactants in effective amounts of, for example, from about 0.01 to about 15, or from about 0.01 to about 5 weight percent of the reaction mixture. Anionic surfactants include sodium dodecylsulfate (SDS), sodium dodecylbenzene sulfonate, sodium dodecylnaphthalene sulfate, dialkyl benzenealkyl, sulfates and sulfonates, abitic acid, available from Aldrich, NEOGEN R™, NEOGEN SC™ obtained from Kao, and the like. Examples of nonionic surfactants for the colorant dispersion selected in various suitable amounts, such as about 0.1 to about 5 weight percent, are polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol, available from Rhone-Ploulenac as IGEPAL CA-210™, IGEPAL CA-520™, IGEPAL, CA-720™, IGEPAL CO-890™, IGEPAL CO-720™, IGEPAL CO-290™, IGEPAL CA-210™, ANTAROX 890™ and ANTAROX 897™.

In a separate container, an initiator solution is prepared. Examples of initiators for the preparation of the latex include water soluble initiators, such as ammonium and potassium persulfates in suitable amounts, such as from about 0.1 to about 8 weight percent, and more specifically, in the range of from about 0.2 to about 5 weight percent. The latex includes both the initial latex and the added delayed latex wherein the delayed latex refers, for example, to the latex portion which is added to the already preformed aggregates in the size range of about 4 to about 6.5 μm, as described below.

In yet another container, a monomer emulsion is prepared by mixing styrene, butyl acrylate, beta-CEA, optionally divinylbenzene if producing the crosslinked resin, and surfactant. In one embodiment, the styrene, butyl acrylate, and/or beta-CEA are olefinic monomers.

Once the preparation of the monomer emulsion is complete, a small portion, for example, about 0.5 to about 5 percent of the emulsion, is slowly fed into a reactor containing the surfactant solution. The initiator solution is then slowly added into the reactor. After about 15 to about 45 minutes, the remainder of the emulsion is added into the reactor.

After about 1 to about 2 hours, but before all of the emulsion is added to the reactor, 1-dodecanethiol or carbon tetrabromide (chain transfer agents that control/limit the length of the polymer chains) is added to the emulsion. In embodiments, the charge transfer agent may be used in effective amounts of, for example, from about 0.05 weight percent to about 15 weight percent of the starting monomers, such as from about 0.1 weight percent to about 13 weight percent or from about 0.1 weight percent to about 10 weight percent of the starting monomers. The emulsion is continued to be added into the reactor.

The monomers may be polymerized under starve fed conditions as referred to in U.S. Pat. No. 6,447,974, incorporated by reference herein in its entirety, to provide latex resin particles having a diameter in the range of from about 20 nanometers to about 500 nanometers, such as from about 75 nanometers to about 400 nanometers or from about 100 to about 300 nanometers.

The weight average molecular weight (Mw) of the non-crosslinked latex resin may be from about 25,000 to about 45,000, such as from about 30,000 to about 37,000, or about 34,000.

The glass transition temperature Tg of the non-crosslinked resin is in the range of from about 40° C. to about 68° C., such as from about 43° C. to about 65° C. or from about 46° C. to about 62° C., or about 58° C.

In addition to the crosslinked resin and the non-crosslinked resin, the toner particles may further include a wax. Examples of waxes suitable for use herein include aliphatic waxes such as hydrocarbon wax having about 1 carbon atom to about 30 carbon atoms, such as from about 1 carbon atom to about 30 carbon atoms or from about 1 carbon atom to about 25 carbon atoms, polyethylene, polypropylene or mixtures thereof.

Examples of waxes suitable for use herein include polypropylenes and polyethylenes commercially available from Allied Chemical and Petrolite Corporation, wax emulsions available from Michaelman Inc. and the Daniels Products Company, EPOLENE N-15™ commercially available from Eastman Chemical Products, Inc., VISCOL 550-P™, a low weight average molecular weight polypropylene available from Sanyo Kasei K.K., and similar materials. Commercially available polyethylenes possess, it is believed, a molecular weight (Mw) of about 1,000 to about 5,000, and commercially available polypropylenes are believed to possess a molecular weight of about 4,000 to about 10,000. Examples of functionalized waxes include amines, amides, for example AQUA SUPERSLIP 6550™, SUPERSLIP 6530™ available from Micro Powder Inc., fluorinated waxes, for example POLYFLUO 190™, POLYFLUO 200™, POLYFLUO 523XF™, AQUA POLYFLUO 411™, AQUA POLYSILK 19™, and POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson Wax.

In embodiments, the wax comprises a wax in the form of a dispersion comprising, for example, a wax having a particle diameter of from about 100 nanometers to about 500 nanometers, water, and an anionic surfactant. In embodiments, the wax is included in amounts such as about 3 to about 30 weight percent. In embodiments, the wax comprises polyethylene wax particles, such as POLYWAX 850, commercially available from Baker Petrolite, having a particle diameter in the range of about 100 to about 500 nanometers. The surfactant used to disperse the wax is an anionic surfactant, such as, for example, NEOGEN RK™ commercially available from Kao Corporation or TAYCAPOWER BN2060 commercially available from Tayca Corporation. Other commercially available polyethylene waxes from Baker Petrolite include POLYWAX 750 and POLYWAX655.

Colorants or pigments include pigments, dyes, mixtures of pigments and dyes, mixtures of pigments, mixtures of dyes, and the like. In embodiments, the colorant comprises a pigment, a dye, mixtures thereof, carbon black, magnetite, black, cyan, magenta, yellow, red, green, blue, brown, mixtures thereof, in an amount of about 1% to about 25% by weight based upon the total weight of the composition. It is to be understood that other useful colorants will become readily apparent to one of skill in the art based on the present disclosure.

In general, useful colorants include Paliogen Violet 5100 and 5890 (BASF), Normandy Magenta RD-2400 (Paul Uhlrich), Permanent Violet VT2645 (Paul Uhlrich), Heliogen Green L8730 (BASF), Argyle Green XP-111-S (Paul Uhlrich), Brilliant Green Toner GR 0991 (Paul Uhlrich), Lithol Scarlet D3700 (BASF), Toluidine Red (Aldrich), Scarlet for Thermoplast NSD Red (Aldrich), Lithol Rubine Toner (Paul Uhlrich), Lithol Scarlet 4440, NBD 3700 (BASF), Bon Red C (Dominion Color), Royal Brilliant Red RD-8192 (Paul Uhlrich), Oracet Pink RF (Ciba Geigy), Paliogen Red 3340 and 3871K (BASF), Lithol Fast Scarlet L4300 (BASF), Heliogen Blue D6840, D7080, K7090, K6910 and L7020 (BASF), Sudan Blue OS (BASF), Neopen Blue FF4012 (BASF), PV Fast Blue B2G01 (American Hoechst), Irgalite Blue BCA (Ciba Geigy), Paliogen Blue 6470 (BASF), Sudan II, III and IV (Matheson, Coleman, Bell), Sudan Orange (Aldrich), Sudan Orange 220 (BASF), Paliogen Orange 3040 (BASF), Ortho Orange OR 2673 (Paul Uhlrich), Paliogen Yellow 152 and 1560 (BASF), Lithol Fast Yellow 0991K (BASF), Paliotol Yellow 1840 (BASF), Novaperm Yellow FGL (Hoechst), Permanerit Yellow YE 0305 (Paul Uhlrich), Lumogen Yellow D0790 (BASF), Suco-Gelb 1250 (BASF), Suco-Yellow D1355 (BASF), Suco Fast Yellow D1165, D1355 and D1351 (BASF), Hostaperm Pink E (Hoechst), Fanal Pink D4830 (BASF), Cinquasia Magenta (DuPont), Paliogen Black L9984 9BASF), Pigment Black K801 (BASF) and particularly carbon blacks such as REGAL 330 (Cabot), Carbon Black 5250 and 5750 (Columbian Chemicals), and the like or mixtures thereof

Additional useful colorants include pigments in water based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RHD 9365X and 9504X (Pigment Red 57 15850:1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YHD 600X and 9604X (Pigment Yellow 14 21095), FLEXIVERSE LFD 4343 and LFD 9736 (Pigment Black 7 77226) and the like or mixtures thereof. Other useful water based colorant dispersions include those commercially available from Clariant, for example, HOSTAFINE Yellow GR, HOSTAFINE Black T and Black TS, HOSTAFINE Blue B2G, HOSTAFINE Rubine F6B and magenta dry pigment such as Toner Magenta 6BVP2213 and Toner Magenta EO2 which can be dispersed in water and/or surfactant prior to use.

Other useful colorants include, for example, magnetites, such as Mobay magnetites MO8029, MO8960; Columbian magnetites, MAPICO BLACKS and surface treated magnetites; Pfizer magnetites CB4799, CB35300, CB35600, MCX6369; Bayer magnetites, BAYFERROX 8600, 8610; Northern Pigments magnetites, NP-604, NP-608; Magnox magnetites TMB-100 or TMB-104; and the like or mixtures thereof, Specific additional examples of pigments include phthalocyanine HELIOGEN BLUE L6900, D6840, D7080, D7020, PYLAM OIL BLUE, PYLAM OIL YELLOW, PIGMENT BLUE 1 available from Paul Uhlrich & Company, Inca, PIGMENT VIOLET 1, PIGMENT RED 48, LEMON CHROME YELLOW DCC 1026, E.D. TOLUIDINE RED and BON RED C available from Dominion Color Corporation, Ltd., Toronto, Ontario, NOVAPERM YELLOW FGL, HOSTAPERM PINK E from Hoechst, and CINQUASIA MAGENTA available from E.I. DuPont de Nemours & Company, and the like. Examples of magentas include, for example, 2,9-dimethyl substituted quinacridone and anthraquinone dye identified in the Color Index as CI 60710, CI Dispersed Red 15, diazo dye identified in the Color Index as CI 26050, CI Solvent Red 19, and the like or mixtures thereof. Illustrative examples of cyans include copper tetra(octadecyl sulfonamide) phthalocyanine, x-copper phthalocyanine pigment listed in the Color Index as CI 74160, CI Pigment Blue, and Anthrathrene Blue identified in the Color Index as DI 69810, Special Blue X-2137, and the like or mixtures thereof. Illustrative examples of yellows that may be selected include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,4-dimethoxy acetoacetanilide, and Permanent Yellow FGL. Colored magnetites, such as mixtures of MAPICOBLACK and cyan components may also be selected as pigments.

Emulsion/aggregation/coalescing processes suitable for the preparation of toners are known in the art. The appropriate components and process known in the art may be selected for the present composition and process in embodiments thereof.

In embodiments, the toner process comprises forming a toner particle by mixing the non-crosslinked latex with a quantity of the crosslinked latex in the presence of a wax and a pigment dispersion to which is added a coagulant, for example poly metal halide, such as, polyaluminum chloride, or other coagulants, while blending at high speeds, such as with a polytron. The resulting mixture having an acidic pH, such as from about 2 to about 3, is aggregated by heating to a temperature below the resin Tg to provide toner size aggregates. Additional non-crosslinked latex may be added to the formed aggregates to provide a shell over the formed aggregates. The pH of the mixture is then changed by the addition of a base, such as sodium hydroxide solution, until a neutral pH, such as of about 7, is achieved. When the mixture reaches a neutral pH, the carboxylic acid becomes ionized to provide additional negative charge on the aggregates thereby providing stability and preventing the particles from further growth or an increase in the size distribution when heated above the Tg of the latex resin. The temperature of the mixture is then raised to about 95° C. After about 30 minutes, the pH of the mixture is reduced to a value sufficient to coalesce or fuse the aggregates to provide a composite particle upon further heating, such as a pH of about 4.5. The fused particles are measured for shape factor or circularity, such as with a Sysmex FPIA 2100 analyzer, until the desired shape is achieved.

The mixture is allowed to cool to room temperature and is washed. A first wash is conducted at a pH of, for example, about 10 and a temperature of about 63° C. followed by a deionized water (DIW) wash at room temperature. This is followed by a wash at a pH of about 4 at a temperature of about 40° C. followed by, a final DIW water wash. The toner is then dried.

While not wishing to be bound by theory, in the present toner composition comprising a non-crosslinked latex, a crosslinked latex, a wax, and a colorant, the crosslinked latex is primarily used to increase the hot offset, while the wax is used to provide release characteristics. The ratio of the non-crosslinked latex to the crosslinked latex, the wax content and the colorant content are selected to control the rheology of the toner.

In embodiments, the toner comprises non-crosslinked resin, crosslinked resin, wax, and colorant in an amount of from about 68 weight percent to about 75 weight percent non-crosslinked resin, about 4 weight percent to about 30 weight percent crosslinked resin or gel, about 3 weight percent to about 25 weight percent wax, and about 7 weight percent to about 13 weight percent colorant, from about 70 weight percent to about 73 weight percent non-crosslinked resin, about 5 weight percent to about 28 weight percent crosslinked resin or gel, about 5 weight percent to about 20 weight percent wax, and about 8 weight percent to about 1 weight percent of the total weight of the toner described herein.

In embodiments, the toner composition exhibits a Mw in the range of about 25,000 to about 40,000 or about 35,000, a Mn in the range of about 9,000 to about 13,000 or about 10,000, and a Tg (onset) of about 48° C. to about 62° C. or about 54° C.

In embodiments, the resultant toner particles possess a shape factor of about 120 to about 140, and a particle circularity of about 0.93 to about 0.985.

In embodiments, the colorant comprises a black pigment such as carbon black. In yet another embodiment, the colorant is a pigment comprising toner particles having a shape factor of about 120 to about 140 where a shape factor of 100 is considered to be spherical and a circularity of about 0.9 to about 0.98 as measured on an analyzer such as a Sysmex FPIA 2100 analyzer, where a circularity of 1 is considered to be spherical in shape.

In another feature, the colorant comprises a pigment dispersion, comprising pigment particles having a volume average diameter of about 50 to about 300 nanometers, water, and an anionic surfactant. For example, the colorant may comprise a carbon black pigment dispersion, such as with Regal 300 carbon black, prepared in an anionic surfactant and optionally a non-ionic surfactant to provide pigment particles having a size of from about 50 nanometers to about 300 nanometers. In embodiments, the surfactant used to disperse the carbon black is an anionic surfactant such as NEOGEN RK™, or TAYCAPOWDER BN 2060. Preferably, an ultimizer type equipment is used to provide the pigment dispersion, although media mill or other means can also be used.

In embodiments, the final toner composition has a gloss, measured at the minimum fixing temperature, of from about 1 to about 20 gloss units, such as from about 2 to about 15 or from about 3 to about 12 gloss units as measured on a BYK 75 degree micro gloss meter. “Gloss units” refers to Gardner Gloss Units measured on plain paper.

One of ordinary skill in the art understands that the toner composition may be utilized in a developer for xerographic printing. Such a developer may further include a carrier. Any known carrier may be utilized with the toner composition described herein to derive a suitable developer.

The following Examples are provided to further illustrate various embodiments of the present disclosure.

### EXAMPLE 1

Preparation of CROSSLINK RESIN A, 50 in 65/35 Styrene/n-Butyl Acrylate Latex Gel

A latex emulsion comprised of polymer gel particles generated from the semi-continuous emulsion polymerization of styrenes n-butyl acrylate, divinylbenzene (DVB), and beta-CEA was prepared as follows.

A surfactant solution consisting of about 6 grams anionic surfactant (NEOGEN RK®) and about 500 grams DIW was prepared by mixing for about 10 minutes in a stainless steel holding tank. The holding tank was then purged with nitrogen for about 5 minutes before transferring into the reactor. The reactor was then continuously purged with nitrogen while being stirred at about 300 RPM. The reactor was then heated up to about 76° C. at a controlled rate and held constant.

In a separate container, about 4.25 grams of ammonium persulfate initiator was dissolved in about 45 grams of DIW.

Also, in yet another separate container, the monomer emulsion was prepared in the following manner: about 162.5 grams of styrene, about 87.5 grams of n-butyl acrylate, about 7.5 grams of beta-CEA, about 2.5 grams of 55% grade divinylbenzene, about 14 grams of anionic surfactant (NEOGEN RK®), and about 270 grams of DIW were mixed to form an emulsion.

The ratio of styrene monomer to n-butyl acrylate monomer by weight was about 65 to about 35 percent. One percent of the above emulsion was then fed into the reactor containing the aqueous surfactant phase at about 76° C. to form the “seeds” while being purged with nitrogen. The initiator solution as then charged into the reactor and after about 20 minutes, the rest of the emulsion was continuously fed in using metering pumps.

Once all the monomer emulsion was charged into the main reactor, the temperature was held at about 76° C. for about an additional 2 hours to complete the reaction. Full cooling was then applied and the reactor temperature was reduced to about 35° C. The product was collected into a holding tank after filtration through an about 1 micron filter bag. After drying a portion of the latex, the onset Tg was about 36.8° C. The average particle size of the crosslinked resin as measured by Disc Centrifuge was about 48 nanometers, and the amount of residual monomer in the resin as measured by gas chromatography (GC) was less than about 50 ppm for styrene and less than about 100 ppm for n-butyl acrylate.

### EXAMPLE 2

Preparation of CROSSLINK RESIN B, 2% DVB, 50 nm 65/35 Styrene/n-Butyl Acrylate Latex Gel

The process of making Crosslink Resin B was the same as in Example 1, except that about 5 g of DVB was used. The onset Tg was 36.9° C. The average particle size of the crosslinked resin as measured by Disc Centrifuge was about 40 nanometers, and the amount of residual monomer in the resin as measured by GC was less than about 50 ppm for styrene and less than about 100 ppm for n-butyl acrylate.

### EXAMPLE 3

Preparation of CROSSLINK RESIN C, 3% DVB, 50 nm 65/35 Styrene/n-Butyl Acrylate Latex Gel

The process of making Crosslink Resin C was the same as in Example 1, except that about 7.5 of DVB was used. The onset Tg was 39.5° C. The average particle size of the latex as measured by Disc Centrifuge was about 41 nanometers, and the amount of residual monomer in the resin as measured by GC was less than about 50 ppm for styrene and less than about 100 ppm for n-butyl acrylate.

### EXAMPLE 4

Preparation of CROSSLINK RESIN D, 100 nm 65/35 Styrene/n-Butyl Acrylate Latex Gel

A latex emulsion comprised of polymer gel particles generated from the semi-continuous emulsion polymerization of styrene, n-butyl acrylate, divinylbenzene, and beta-CEA was prepared as follows.

A surfactant solution consisting of about 4 grams anionic surfactant (NEOGEN RK®) and about 500 grams DIW was prepared by mixing for about 10 minutes in a stainless steel holding tank. The holding tank was then purged with nitrogen for about 5 minutes before transferring into the reactor. The reactor was then continuously purged with nitrogen while being stirred at about 300 RPM. The reactor was then heated up to about 76° C. at a controlled rate and held constant.

In a separate container, about 8.1 grams of ammonium persulfate initiator was dissolved in about 45 grams of DIW.

In yet another separate container, the monomer emulsion was prepared in the following manner: about 351 grams of styrenes about 189 grams of n-butyl acrylate, about 16.2 grams of beta-CEA, about 5.4 grams of 55% grade divinylbenzene, about 9.5 grams anionic surfactant (NEOGEN RK®), and about 270 grams of DIW were mixed to form an emulsion. The ratio of styrene monomer to n-butyl acrylate monomer by weight was about 65 to about 35 percent.

One percent of the above emulsion was then slowly fed into the reactor containing the aqueous surfactant phase at about 76° C. to form the “seeds” while being purged with nitrogen. The initiator solution was then slowly charged into the reactor, and after about 20 minutes the rest of the emulsion is continuously fed in using metering pumps.

Once all the monomer emulsion was charged into the main reactor, the temperature was held at about 76° C. for about an additional 2 hours to complete the reaction. Full cooling was then applied and the reactor temperature was reduced to about 35° C. The product was collected into a holding tank after filtration through an about 1 micron filter bag. After during a portion of the latex, the onset Tg was about 40.4° C. The average particle size of the crosslinked resin as measured by Disc Centrifuge was about 97 nanometers, and the amount of residual monomer in the resin as measured by GC was less than about 50 ppm for styrene and less than about 100 ppm for n-butyl acrylate.

### EXAMPLE 5

Preparation of CROSSLINK RESIN E, 100 nm 100/0 Styrene/n-Butyl Acrylate Latex Gel

The process of making Crosslink Resin F was the same as in Example 4, except about 542 grams styrene was used and no butyl acrylate was used. The Tg (onset) was about 100° C. The average particle size of the crosslinked resin as measured by Disc Centrifuge was about 108 nanometers, and the amount of residual monomer in the resin as measured by GC was less than about 50 ppm for styrene and less than about 100 ppm for n-butyl acrylate.

### EXAMPLE 6

Preparation of CROSSLINK RESIN F, 20 nm 65/35 Styrene/n-Butyl Acrylate Latex Gel

A latex emulsion comprised of polymer gel particles generated from the semi-continuous emulsion polymerization of styrene, n-butyl acrylate, divinylbenzene, and beta-CEA was prepared as follows.

A surfactant solution consisting of about 9.0 grams anionic surfactant (NEOGEN RK®) and about 500 grams DIW was prepared by mixing for about 10 minutes in a stainless steel holding tank. The holding tank was then purged with nitrogen for about 5 minutes before transferring into the reactor. The reactor was then continuously purged with nitrogen while being stirred at about 300 RPM. The reactor was then heated up to about 76° C. at a controlled rate and held constant.

In a separate container, about 4.25 grams of ammonium persulfate initiator was dissolved in about 45 grams of DIW.

In yet another separate container, the monomer emulsion was prepared in the following manner: about 162.5 grams of styrene, about 87.5 grams of n-butyl acrylate, about 7.5 grams of beta-CEA, about 2.5 grams of 55% grade divinylbenzene, about 21 grams anionic surfactant (NEOGEN RK®), and about 270 grams of DIW were mixed to form an emulsion, The ratio of styrene monomer to n-butyl acrylate monomer by weight was about 65 to about 35 percent.

One percent of the above emulsion was then slowly fed into the reactor containing the aqueous surfactant phase at about 76° C. to form the “seeds” while being purged with nitrogen. The initiator solution was then slowly charged into the reactor and after about 2-0 minutes the rest of the emulsion was continuously fed in using metering pumps. Once all the monomer emulsion was charged into the main reactor, the temperature was held at about 76° C. for about an additional 2 hours to complete the reaction. Full cooling was then applied and the reactor temperature is reduced to about 35° C.

The product was collected into a holding tank after filtration through an about 1 micron filter bag. After drying a portion of the latex, the Tg (onset) was about 41.3° C. The average particle size of the crosslinked resin as measured by Disc Centrifuge was about 30 nanometers, and amount of residual monomer in the resin as measured by GC was less than about 50 ppm for styrene and less than about 100 ppm for n-butyl acrylate.

### EXAMPLE 7

Preparation of CROSSLINK RESIN G, 20 nm 100/0 styrene/n-Butyl Acrylate Latex Gel was the same as in Example 7 above, except that about 250 grams of styrene was included instead of butyl acrylate. The Tg (onset) was about 100° C. The average particle size of the crosslinked resin as measured by Disc Centrifuge was about 38 nanometers, and the amount of residual monomer in the resin as measured by GC was less than about 50 ppm for styrene and less than about 100 ppm for n-butyl acrylate.

### Preparation of EA Toner for Examples 9 Through 14

The method of producing the substantially non-crosslinked resin used in making toners 8 through 14, as described below, was as follows. A surfactant solution consisting of about 0.8 grams Dowfax 2A1 (anionic emulsifier) and about 514 grains of de-ionized water was prepared by mixing for about 10 minutes in a stainless steel holding tank. The holding tank was then purged with nitrogen for about 5 minutes before transferring into the reactor. The reactor was then continuously purged with nitrogen while being stirred at about 300 RPM. The reactor was then heated up to about 76 degrees at a controlled rate, and held there. Separately, about 8.1 grams of ammonium persulfate initiator was dissolved in about 45 grams of de-ionized water.

Separately, the monomer emulsion was prepared in the following manner. About 413.1 grams of styrene, about 126.9 grams of butyl acrylate, about 16.2 of beta-CEA, about 3.78 grains of 1-dodecanethiol, about 1.89 grams of decanediol diacrylate, about 10.69 grains of Dowfax 2A1 (anionic surfactant), and about 257 grams of deionized water were mixed to form an emulsion. About 1 percent of the above emulsion was then slowly fed into the reactor containing the aqueous surfactant phase at about 76° C. to form the “seeds” while being purged with nitrogen. The initiator solution was then slowly charged into the reactor and after about 10 minutes, the rest of the emulsion was continuously fed in a using metering pump at a rate of about 0.5 percent/min. Once half of the monomer emulsion was charged into the main reactor, about an additional 4.54 grams of 1-dodecanethiol are added to the monomer emulsion. Once all of the monomer emulsion was charged into the main reactor, the temperature was held at about 76° C. for about an additional 2 hours to complete the reaction. Full cooling was then applied and the reactor temperature was reduced to about 35° C. The product was collected into a holding tank. After drying the latex the molecular properties were Mw=35,419 Mn=11,354 and the onset Tg was 51.0° C.

About (1) 221 grams of the substantially non-crosslinked resin having a solids loading of about 41.93 weight percent, (Mw/Mn=35,000/10,500, Tg onset=52° C.), about 60.29 grams of POLYWAX 850 wax emulsion having a solids loading of about 30.6 weight percent, about 126.12 grams of black pigment dispersion (REGAL 330®) having a solids loading of about 17 weight percent, and about 81.63 grams of one of Crosslink Resin A through G, as set forth in Table 1 below, laving a solids content of about 24.5 weight percent, are added to about 547.5 grams of DIW in a vessel while being stirred using an IKA ULTRA TURRAX® T50 homogenizer operating at about 4,000 RPM.

After about 5 minutes of homogenizing the solution at about 4000 RPM, a drop-wise addition of about 34 grams of a flocculent mixture containing about 3.4 grams polyaluminum chloride mixture and about 30.6 grams of 0.02 molar nitric acid solution was added to the solution. As the flocculent mixture was added drop-wise, about an additional 135 grams of DIW was added to the mixture, and the homogenizer speed was increased to about 5,200 RPM and homogenized for about an additional 5 minutes.

Thereafter, the mixture was heated at about 11° C. per minute to a temperature of about 51° C., and held there for a period of about 1.5 to about 2 hours, resulting in a volume average particle diameter of about 5.2 microns as measured with a Coulter Counter. During this heat up period, the stirrer was run at about 250 RPM, and about 110 minutes after the set temperature of about 51° C. was reached, the stirrer speed was reduced to about 2.20 RPM.

About an additional 136.7 grams of non-crosslinked toner resin was added to the reactor mixture and heated to a temperature of about 52° C. and held there for about an additional 30 minutes resulting in a volume average particle diameter of about 5.8 microns. Adjusting the reactor mixture pH to about 6 with 1.0 M sodium hydroxide solution halts any further increase in the particle size. Thereafter, the reactor mixture was heated at about 1° C. per minute to a temperature of about 93° C. followed by adjusting the reactor mixture pH to about 4.0 with 0.3 M nitric acid solution.

Following this, the reactor mixture was gently stirred at about 93° C. for about 5 hours to enable the particles to coalesce and spherodize. Following about a full 5 hours at about 93° C., the reactor heater was turned off and the reactor mixture was allowed to cool to room temperature at a rate of about 1° C. per minute.

The resulting toner mixture included about 16.7 weight percent of toner particles, about 0.25 weight percent of anionic surfactant and about 82.9 weight percent of water. The toner particles of this mixture included about 71 weight percent of styrene/acrylate polymer, about 10 weight percent of REGAL 330® pigment, about 9 weight percent of wax (POLYWAX 850), and about 10 weight percent of the crosslinked resin. The toner particles had a volume average particle diameter of about 5.7 microns and a GSD of about 1.25. The particles were washed about 6 times, where the first wash was conducted at a pH of about 10 at about 63° C., followed by 3 washes with DIW at room temperature, one wash was carried out at a pH of about 41 at about 40° C., and finally the last wash with DIW at room temperature.

TABLE 1
Toner and Crosslinked Resin for Examples 10 through 18.

| TONER EXAMPLE NO. | CROSSLINK RESIN |
|---|---|
| 8 | A |
| 9 | B |
| 10 | C |
| 11 | F |
| 12 | D |
| 13 | E |
| 14 | G |

### Toner Fusing Evaluation

All toners were fused onto paper using a bench fuser.

Crosslinked Resin Content

It was shown that the amount of crosslinked resin within the toner had a dramatic effect on the fused image gloss. As the amount of crosslinked resin is increased in the toner, the gloss decreased. The target for gloss was less than 12 ggu. Therefore, at least about 9% by weight of the crosslinked resin must be added to the toner to reduce the gloss below 12 ggu. However, toners with gloss lower than 20 ggu may still be used as a matte toner, depending upon the requirement of different print engines.

DVB Concentration in the Crosslinked Resin Formulation

It was shown that the amount of divinylbenzene in the crosslinked resin formulation between 1 and 3 weight percent by weight of monomer had little to no effect on the fused image gloss. These amounts of divinylbenzene also did not impact minimum fixing temperature (MFT).

Crosslinked Resin Composition

It was found that the styrene/butyl acrylate ratio in the crosslink resin formulation had an impact on the fused image gloss of the toner. While the MFT remains unaffected by decreasing amounts of styrene in the resin formulation, the gloss decreases with decreasing styrene content in the crosslinked resin formulation. For this reason, a 65:35 ratio of styrene:butyl acrylate was used in the crosslinked resin to obtain a low gloss fixed toner image.

Crosslinked Resin Size

It was found that the size of the crosslinked resin had a slight impact on the fused image gloss of the toner. Specifically, the gloss decreased with a decreased crosslink resin size. For this reason, the crosslinked resin size may be from about 15 nanometers to about 70 nanometers to obtain a low gloss fixed toner image.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

1. A toner composition having emulsion aggregation toner particles comprised of:
a crosslinked resin;
a substantially non-crosslinked resin;
a wax; and
a colorant,
wherein the crosslinked resin has a crosslinked density of from about 0.3 percent to about 30 percent.

2. The toner composition according to claim 1, wherein the substantially non-crosslinked resin has a crosslinked density of less than about 0.1.

3. The toner composition according to claim 1, wherein the crosslinked resin comprises from about 30 weight percent to about 99.9 weight percent styrene, from about 5 weight percent to about 50 weight percent butyl acrylate, from about 0.05 weight percent to about 15 weight percent of a carboxyl acid group containing monomer, and 0.25 weight percent to about 15 weight percent divinylbenzene.

4. The toner composition according to claim 1, wherein a ratio of styrene to butyl acrylate in the crosslinked resin is from about 50:50 to about 80:20 of styrene:butyl acrylate.

5. The toner composition according to claim 3, wherein the carboxyl acid group containing monomer is beta-carboxyethylacrylate.

6. The toner composition according to claim 1, wherein the emulsion aggregation toner particles comprise from about 4 weight percent to about 30 weight percent of crosslinked resin.

7. The toner composition according to claim 1, wherein the emulsion aggregation toner particles have a gloss of from about 1 gloss unit to about 20 gloss units.

8. The toner composition according to claim 7, wherein the gloss is from about 1 gloss unit to about 12 gloss units.

9. The toner composition according to claim 6, wherein the emulsion aggregation toner particles comprise from about 68 weight percent to about 75 weight percent non-crosslinked resin, from about 3 weight percent to about 25 weight percent wax, and from about 7 weight percent to about 13 weight percent colorant.

10. The toner composition according to claim 1, wherein the crosslinked resin has a particle diameter of from about 10 nanometers to about 35 nanometers.

11. (canceled)

12. The toner composition according to claim 1, wherein the substantially non-crosslinked resin is selected from the group consisting of styrene acrylates, styrene methacrylates, butadienes, isoprene, acrylonitrile, acrylic acid, methacrylic acid, beta-carboxyethylacrylate, polyesters, poly(styrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and styrene/butyl acrylate/carboxylic acid terpolymers, styrene/butyl acrylate/beta-carboxyethylacrylate terpolymers, and mixtures thereof.

13. The toner composition according to claim 1, wherein the substantially non-crosslinked resin comprises styrene:butyl acrylate:beta-carboxyethylacrylate.

14. The toner composition according to claim 1, wherein the wax is an alkylene, a polyethylene, a polypropylene, or mixtures thereof.

15. A developer comprising:
the toner composition according to claim 1; and
a carrier.

16. An emulsion aggregation toner process comprising:
mixing crosslinked resin having a crosslinked density of from about 0.3 percent to about 30 percent, a substantially non-crosslinked resin, a wax and a colorant to provide toner size aggregates;
heating the aggregates to form a toner; and
optionally, isolating the toner.

17. The emulsion aggregation toner process according to claim 16, wherein the substantially non-crosslinked resin has a crosslinked density of less than about 0.1.

18. The emulsion aggregation toner process according to claim 16, wherein the heating comprises a first heating below the glass transition temperature of the substantially non-crosslinked resin and a second heating above the glass transition temperature of the substantially non-crosslinked resin.

19. The emulsion aggregation toner process according to claim 16, wherein the crosslinked resin comprises styrene, butyl acrylate, carboxyl acid group containing monomer, and divinylbenzene.

20. The emulsion aggregation toner process according to claim 19, wherein the carboxyl acid group containing monomer is beta-carboxyethylacrylate.

21. A method of developing an image, comprising:
applying a toner composition comprised of emulsion aggregation toner particles to a substrate to form an image, the emulsion aggregation toner particles comprising a crosslinked resin, a substantially non-crosslinked resin, a wax, and a colorant, and
fusing the toner composition to the substrate,
wherein the crosslinked resin has a crosslinked density of from about 0.3 percent to about 30 percent.

22. The method according to claim 21, wherein the substantially non-crosslinked resin has a crosslinked density of less than about 0.1.

23. The method according to claim 21, wherein the crosslinked resin comprises styrene, butyl acrylate, carboxyl acid group containing monomer, and divinylbenzene.

24. The method according to claim 23, wherein the carboxyl acid group containing monomer is beta-carboxyethylacrylate.
